(19) United States
(12) Patent Application Publication
(10) Pub. No.: US 2026/0169407 A1
(43) Pub. Date: Jun. 18, 2026

(54) FIXING DEVICE

(71) Applicant: CANON KABUSHIKI KAISHA, Tokyo (JP)

(72) Inventors: TORU IMAIZUMI, Kanagawa (JP); TAKAAKI AKAMATSU, Kanagawa (JP); SHOICHIRO IKEGAMI, Kanagawa (JP); HIROKI SASAME, Tokyo (JP)

(21) Appl. No.: 19/417,108

(22) Filed: Dec. 11, 2025

(30) Foreign Application Priority Data
Dec. 16, 2024 (JP) 2024-219606

(51) Int. Cl. G03G 15/20; G03G 21/16

(52) U.S. Cl. CPC G03G 15/2032; G03G 15/206; G03G 15/2064; G03G 21/1619; G03G 2215/2035

(57) ABSTRACT

A fixing device is configured to fix a toner image formed on a recording material onto the recording material while nipping the recording material at a fixing nip and conveying the recording material through the fixing nip. The fixing device includes a protective member disposed between a pressure arm and a portion of a regulating member that is pressed by the pressure arm.

### BACKGROUND

### Field of the Technology

The present disclosure relates to a fixing device disposed in an image forming apparatus employing an electrophotographic method.

### Description of the Related Art

Known fixing devices adopting an on-demand fixing method, such as those described in Japanese Patent Laid-Open No. 2024-31208, are used in an image forming apparatus employing an electrophotographic method.

### SUMMARY

The present disclosure is directed to further developing the above-described conventional technique.

According to some embodiments of the present disclosure, a fixing device configured to fix a toner image formed on a recording material onto the recording material while nipping the recording material at a fixing nip and conveying the recording material through the fixing nip, includes a belt unit including a belt which is cylindrical, a heater disposed in an internal space of the belt, a holder that holds the heater, and a regulating member disposed at a position facing an end portion of the belt in a longitudinal direction of the belt and configured to regulate movement of the belt in the longitudinal direction of the belt, a pressure roller configured to contact an outer circumferential surface of the belt and to form the fixing nip between the pressure roller and the belt while sandwiching the belt together with the heater, a frame that rotatably supports the pressure roller and supports the regulating member to support the belt unit, and a pressure arm rotatably disposed on the frame and configured to apply pressure to the regulating member to form the fixing nip, the pressure arm being made of metal, wherein the frame is made of resin, wherein, when viewed in the longitudinal direction of the belt, a rotation center axis of the pressure arm is located on an upstream side of the fixing nip in a recording material conveyance direction and between a rotation center of the pressure roller and an end portion of the holder on a side where the pressure arm is disposed in a direction orthogonal to the longitudinal direction of the belt and the recording material conveyance direction, and wherein a protective member made of resin is disposed between the pressure arm and a portion of the regulating member that is pressed by the pressure arm, and the pressure arm presses the regulating member via the protective member.

According to another aspect of the present disclosure, a fixing device configured to fix a toner image formed on a recording material onto the recording material while nipping the recording material at a fixing nip and conveying the recording material through the fixing nip, includes a belt unit including a belt which is cylindrical, a heater disposed in an internal space of the belt, a holder that holds the heater, and a regulating member disposed at a position facing an end portion of the belt in a longitudinal direction of the belt and configured to regulate movement of the belt in the longitudinal direction of the belt, a pressure roller configured to contact an outer circumferential surface of the belt and to form the fixing nip between the pressure roller and the belt while sandwiching the belt together with the heater, a frame that rotatably supports the pressure roller and supports the regulating member to support the belt unit, and a pressure arm rotatably disposed on the frame and configured to apply pressure to the regulating member to form the fixing nip, the pressure arm being made of metal, wherein the frame is made of resin, wherein, when viewed in the longitudinal direction of the belt, a rotation center axis of the pressure arm is located on an upstream side of the fixing nip in a recording material conveyance direction and between a rotation center of the pressure roller and an end portion of the holder on a side where the pressure arm is disposed in a direction orthogonal to the longitudinal direction of the belt and the recording material conveyance direction, and wherein a lubricant is applied between the pressure arm and a portion of the regulating member to be pressed by the pressure arm, and the pressure arm presses the regulating member via the lubricant.

By employing the above-described technique, a fixing device with a configuration further developed from conventional configurations is provided.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of a fixing device.

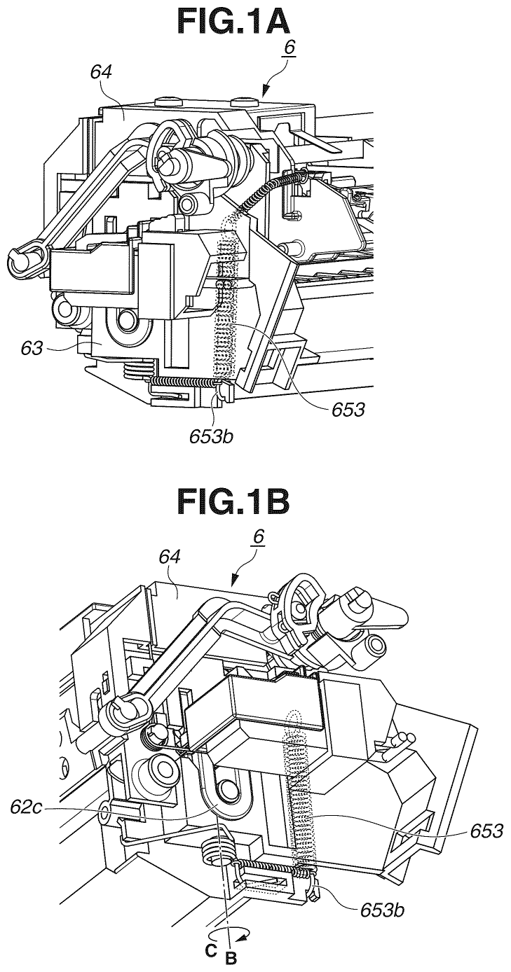

FIG. 2 is a cross-sectional view of an image forming apparatus.

FIG. 3 is a cross-sectional view of a heating unit and a pressure roller.

FIG. 4 is a cross-sectional view of the fixing device.

FIG. 5 is an exploded perspective view of the fixing device.

FIG. 6 is a top view of a holder.

FIG. 7 is an exploded perspective view of the heating unit.

FIG. 8 is a top view of the heating unit.

FIG. 9A is a front view, and FIGS. 9B to 9D are cross-sectional views of the fixing device according to a first embodiment.

FIG. 10A is a top view, and FIGS. 10B and 10C are enlarged views of a lower frame and a pressure roller according to the first embodiment.

FIGS. 11A and 11B are cross-sectional views of a pressure mechanism and a pressure release mechanism in a pressurized state and a depressurized state, respectively, according to the first embodiment.

FIG. 12 is an exploded perspective view of a lower frame, an upper frame, a camshaft, and a cam according to the first embodiment.

FIGS. 13A and 13B are diagrams illustrating an attached state of a wear-preventing member according to the first embodiment.

FIGS. 14A and 14B are cross-sectional views of a pressure mechanism and a pressure release mechanism in a pressurized state and a depressurized state, respectively, in Comparative Example 1.

FIGS. 15A and 15B are views illustrating an attached state of a pressure arm support portion according to a second embodiment.

FIGS. 16A and 16B are cross-sectional views of a pressure mechanism and a pressure release mechanism in a pressurized state and a depressurized state, respectively, according to a third embodiment.

### DESCRIPTION OF THE EMBODIMENTS

### First Embodiment

Hereinafter, various exemplary embodiments, features, and aspects of the present disclosure will be described in detail with reference to the accompanying drawings.

### [Image Forming Apparatus]

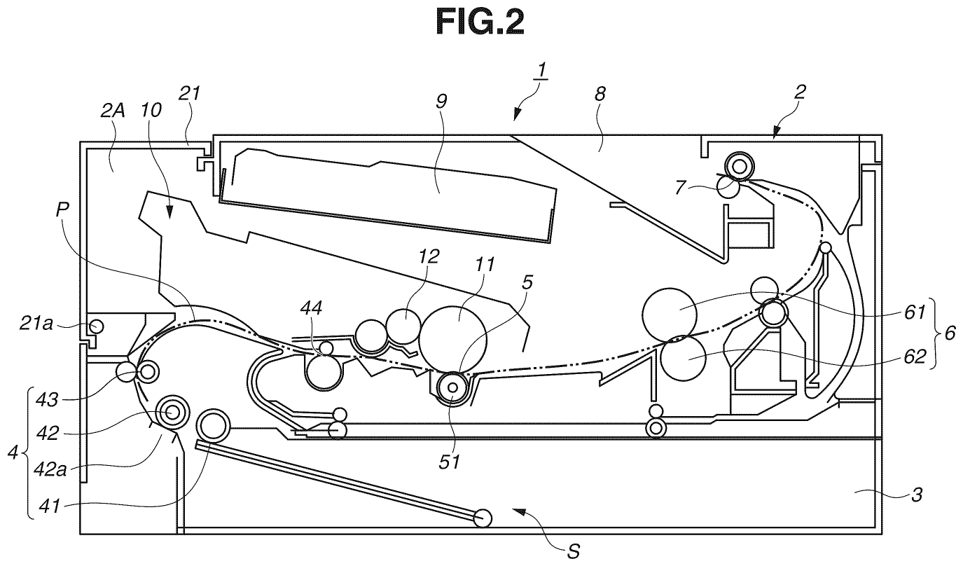

FIG. 2 is a cross-sectional view of an image forming apparatus 1 employing an electrophotographic method in a first embodiment. Dimensions, materials, shapes, and relative arrangements of components described in the embodiments may be appropriately changed depending on the configuration of the apparatus to which the present disclosure is applied and various conditions. Thus, unless otherwise specifically stated, the scope of the present disclosure is not limited thereto. In the following description, the left side in FIG. 2 is defined as the front side of the image forming apparatus 1, and the right side is defined as the rear side. The near side of the drawing is defined as the right side of the image forming apparatus 1, and the far side of the drawing is defined as the left side of the image forming apparatus 1. The upper and lower sides in FIG. 2 are defined as the upper and lower sides of the image forming apparatus 1, respectively.

As illustrated in FIG. 2, the image forming apparatus 1 includes an apparatus main body 2 and a process cartridge 10. The process cartridge 10 is detachably mounted on the apparatus main body 2. The apparatus main body 2 includes a sheet feed tray 3, a recording material feeding unit 4, a conveyance path P, an image forming unit 5, a fixing device 6, a recording material discharge unit 7, a discharge tray 8, a laser scanner 9, and other components. The cartridge 10 includes a photoconductor drum 11, a developing roller 12 serving as a developer carrying member, and other components.

The apparatus main body 2 is provided with an opening 2A through which the process cartridge 10 is attached and detached, and an open/close door 21 for closing the opening 2A. The open/close door 21 is rotatably supported about a rotation shaft 21a and is movable between a closed position in which the opening 2A is closed and an open position in which the opening 2A is opened.

The recording material feeding unit 4 includes a sheet feed roller 41, a separation roller 42, a separation pad 42a, and a pair of conveyance rollers 43. A recording material S stored in the sheet feed tray 3 is fed to the conveyance path P by the recording material feeding unit 4 based on a print start signal and is conveyed toward the image forming unit 5 via a pair of registration rollers 44. When the recording material S is conveyed to a predetermined position, an image forming start signal is issued, and an image forming process is started. A photoconductor drum 11 rotationally driven by a drive source (motor), which is not illustrated, is uniformly charged to a predetermined potential by a charging unit (not illustrated). The photoconductor drum 11 having been charged is exposed on its surface to light by the laser scanner 9 based on image information, so that the charge on the exposed portions is removed to form an electrostatic latent image. Toner in the process cartridge 10 is carried on the developing roller 12 and supplied to the photoconductor drum 11 in accordance with the electrostatic latent image to develop the latent image. Thus, the latent image is visualized as a toner image on the photoconductor drum 11.

The image forming unit 5 includes the process cartridge 10 and a transfer roller 51 disposed to face the photoconductor drum 11 of the process cartridge 10. When the recording material S conveyed by the pair of registration rollers 44 reaches the image forming unit 5 and passes through a transfer nip between the photoconductor drum 11 and the transfer roller 51, a voltage is applied to the transfer roller 51 from the apparatus main body 2, and the toner image on the photoconductor drum 11 is transferred onto the recording material S. Thereafter, the recording material S onto which the toner image has been transferred is conveyed to the fixing device 6. The fixing device 6 includes a heating unit 61 and a pressure roller 62 that contacts an outer circumferential surface of a cylindrical belt 614. When the recording material S is nipped at a fixing nip NP1 between the heating unit 61 and the pressure roller 62 and then conveyed therethrough, the toner image transferred onto the recording material S is heated and pressed to be fixed on a surface of the recording material S. The recording material S on which the toner image has been fixed is discharged to the discharge tray 8 via the recording material discharge unit 7.

### [Fixing Device]

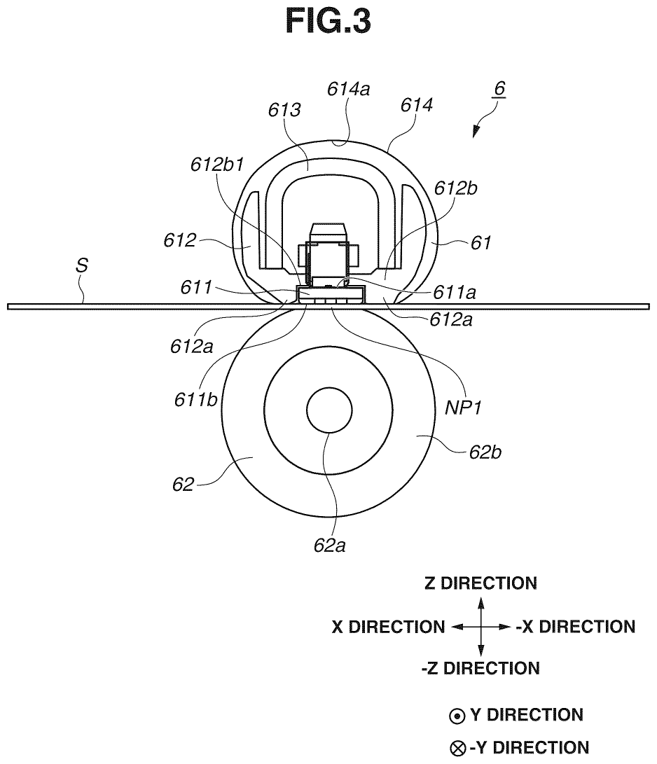

Next, a specific configuration of the fixing device will be described with reference to FIG. 3 to FIG. 8. As illustrated in FIG. 3, the heating unit (belt unit) 61 of the fixing device 6 includes a heater 611, a holder 612, a stay 613, a belt 614, and transmission members (regulating members) 651a and 651b. The heater 611, the holder 612, and the stay 613 are disposed in an internal space of the belt 614. When directions X, Y, and Z are defined as illustrated in FIG. 3, the heater 611 is in the form of a flat plate extending in the Y direction, and the Y direction coincides with a longitudinal direction of the belt 614. The heater 611 has a first surface 611a and a second surface 611b opposite to the first surface 611a, and the first surface 611a is supported by the holder 612.

The holder 612 is formed of heat-resistant resin, such as polyphenylene sulfide (PPS) or liquid crystal polymer, and includes a guide surface 612a and a support wall 612b. The guide surface 612a contacts an inner circumferential surface 614a of the belt 614 to guide the belt 614, and the support wall 612b includes a support surface 612b1 that supports the heater 611. The support surface 612b1 of the support wall 612b is in contact with the first surface 611a of the heater 611. The stay 613 is a member that supports the holder 612 and is configured as a substantially-U-shaped bent plate material. The plate material has greater rigidity than the holder 612, for example, a steel sheet having a thickness of about 1.6 mm (millimeter).

The belt 614 is an endless belt with heat resistance and flexibility. Examples include a metal sleeve, such as one made of stainless steel, coated with fluororesin, or a laminated structure of polyimide resin, silicone rubber, fluororesin, and the like. The heater 611, the holder 612, and the stay 613 are disposed inside the belt 614, and the belt 614 rotates around these members. The inner circumferential surface 614a of the belt 614 contacts the second surface 611b of the heater 611.

The pressure roller 62 includes a metal shaft 62a and a roller 62b made of an elastic material covering the shaft 62a, and is pressed against the heater 611 via the belt 614. The pressure roller 62 forms the fixing nip NP1 for heating and pressing the recording material S by sandwiching the belt 614 between the pressure roller 62 and the heater 611. Specifically, the pressure roller 62 heats and presses the recording material S together with the heater 611 at the fixing nip NP1.

The pressure roller 62 is configured to be rotationally driven by driving force transmitted from a drive source of the image forming apparatus 1. When the pressure roller 62 is rotationally driven, the belt 614 is driven to rotate by frictional force either with the pressure roller 62 or with the recording material S nipped in the fixing nip NP1. As a result, the recording material S on which the toner image has been transferred is conveyed between the pressure roller 62 and the heated belt 614, thus thermally fixing the toner image.

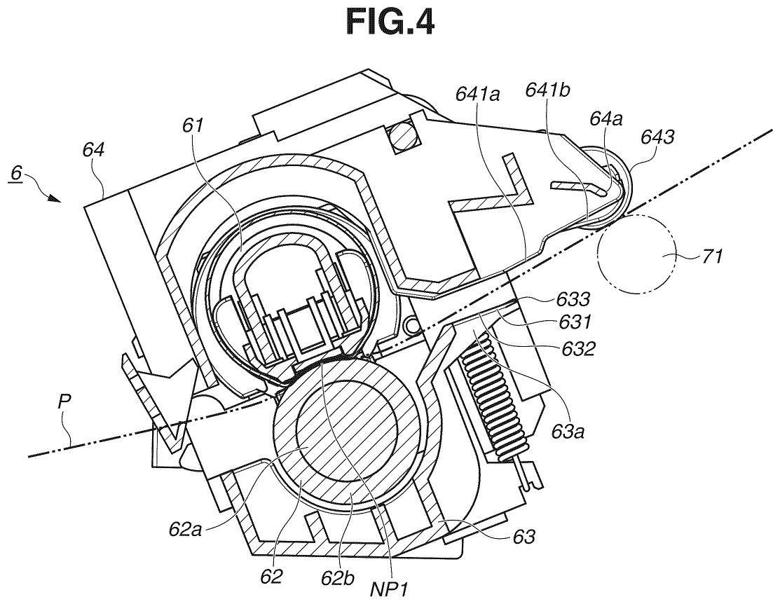

As illustrated in FIGS. 4 to 8, the fixing device 6 includes a lower frame 63 that supports the heating unit 61 and the pressure roller 62, and an upper frame 64 that is disposed above the lower frame 63 and covers the heating unit 61. The upper frame 64 includes an upper recording material guide 64a that guides an upper surface of the recording material S conveyed along the conveyance path P on a downstream side of the heating unit 61 and the pressure roller 62 in a recording material conveyance direction. The lower frame 63 includes a lower recording material guide 63a that guides a lower surface of the recording material S conveyed along the conveyance path P on a downstream side of the heating unit 61 and the pressure roller 62 in the recording material conveyance direction.

The conveyance path P in the fixing device 6 extends in the X direction. In the present embodiment, the lower frame 63 and the upper frame 64 are formed of, for example, non-conductive molded members. Examples of materials of the molded members include polyethylene terephthalate (PET), polybutylene terephthalate (PBT), and polyphenylene sulfide (PPS). PET or PBT may be reinforced with glass fibers.

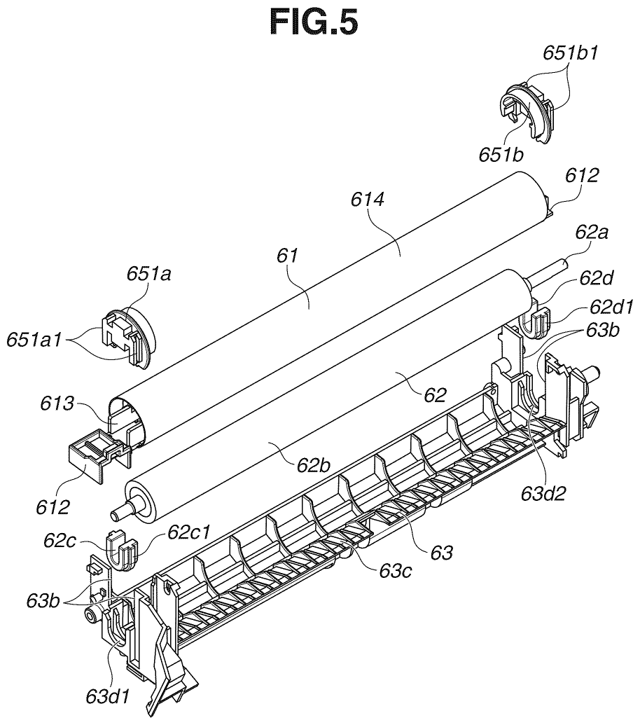

As illustrated in FIG. 5, the lower frame 63 supports the heating unit 61 and the pressure roller 62. The lower frame 63 includes a pair of rails 63b at the respective ends in the Y direction. The pairs of rails 63b support the holder 612 so as to be movable in the Z direction (first direction) via the transmission members (regulating members) 651a and 651b that transmit pressure to the stay 613 (details will be described below). The transmission members (regulating members) 651a and 651b regulate the movement of the belt 614 in the longitudinal direction of the belt 614. The rails 63b are each a columnar portion extending in the Z direction from a main body 63c of the lower frame 63. In each pair of rails 63b, the two rails face each other in the X direction. Opposing surfaces of the respective pairs of rails 63b engage with the corresponding groove portion of a groove portion 651a1 of the transmission member 651a and a groove portion 651b1 of the transmission member 651b. In the present embodiment, the rails 63b are each a columnar portion extending in the Z direction, but any shape with which the holder 612 can be supported so as to be movable in the Z direction may be used. The shape is not limited to that in the present embodiment.

The pressure roller 62 is rotatably supported by the lower frame 63 via bearings 62c and 62d at both ends of the metal shaft 62a in the longitudinal direction. At this time, a protrusion 62c1 on the bearing 62c fits into a groove 63d1 on the lower frame 63, thus positioning the bearing 62c. Similarly, a protrusion 62d1 on the bearing 62d fits into a groove 63d2 on the lower frame 63, thus positioning the bearing 62d. The bearing 62c is formed of a conductive material. In the present embodiment, the bearings 62c and 62d are provided with the protrusions 62c1 and 62d1, respectively, and the lower frame 63 is provided with the grooves 63d1 and 63d2. Alternatively, the bearings 62c and 62d may be provided with grooves and the lower frame 63 may be provided with protrusions.

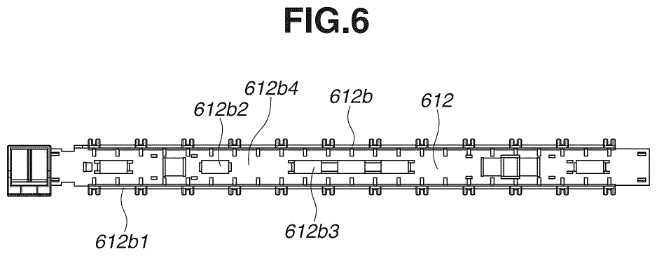

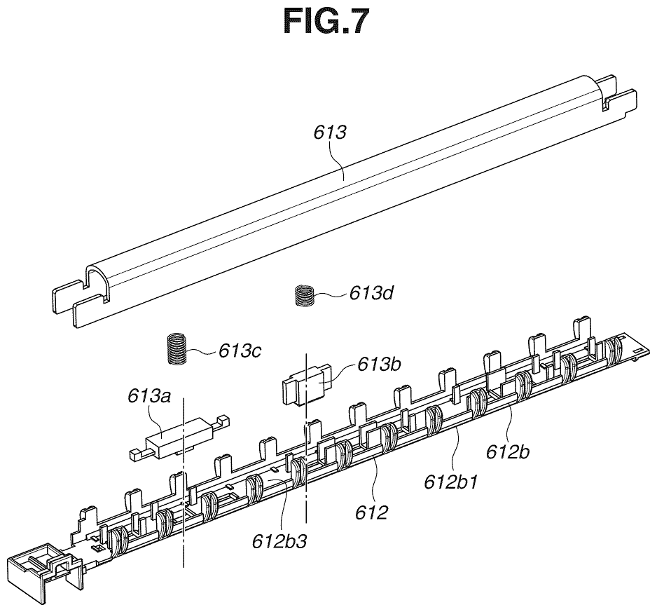

As illustrated in FIG. 6, the support wall 612b of the holder 612 has a plurality of holes 612b2 and 612b3. As illustrated in FIGS. 6 and 7, temperature sensors 613a and 613b are disposed facing a back surface 612b4 of the holder 612, which is opposite to the support surface 612b1 of the holder 612. As illustrated in FIG. 7, the temperature sensors 613a and 613b contact the first surface 611a of the heater 611 through the holes 612b2 and 612b3. The temperature sensors 613a and 613b are pressed against the first surface 611a of the heater 611 (see FIG. 3) by biasing members 613c and 613d disposed between the stay 613 and the temperature sensors 613a and 613b, respectively. The temperature sensor 613a is located at one end of the holder 612 in the Y direction. The temperature sensor 613b is located one end side of the center of the holder 612 in the Y direction. The temperature sensors 613a and 613b are thermistors in the present embodiment, but may be other temperature sensors, such as thermostats. The biasing members 613c and 613d are coil springs in the present embodiment, but may be other biasing members.

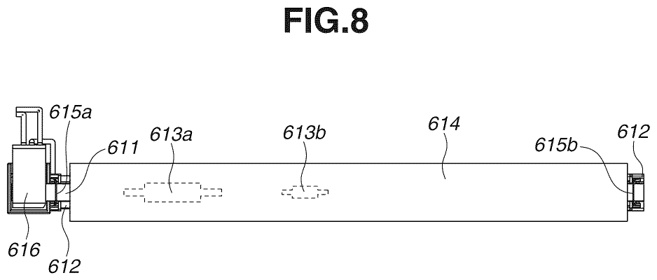

As illustrated in FIGS. 5 and 8, the holder 612 extends in the Y direction inside the belt 614, and both ends of the holder 612 in the Y direction protrude outward from the belt 614. The holder 612 supports the heater 611, and one end in the Y direction of the heater 611 is provided with a first wire spring 615a that holds the heater 611 on the holder 612, and a connector 616 that supplies power to the heater 611 and clamps the heater 611 and the holder 612 together. The other end in the Y direction of the heater 611 is provided with a second wire spring 615b that holds the heater 611 on the holder 612.

The temperature sensors 613a and 613b are located closer to the first wire spring 615a than to the second wire spring 615b in the Y direction. The first wire spring 615a is disposed between the belt 614 and the connector 616. The second wire spring 615b is disposed in a region protruding outward from the belt 614 on the end opposite to the end where the first wire spring 615a is disposed. In the present embodiment, the pressure roller 62 includes the shaft 62a and the roller 62b, but the configuration of the pressure roller 62 is not limited thereto. Alternatively, a pressure belt which is pressed against a heating roller by an elastic member may be provided.

### [Pressure Mechanism]

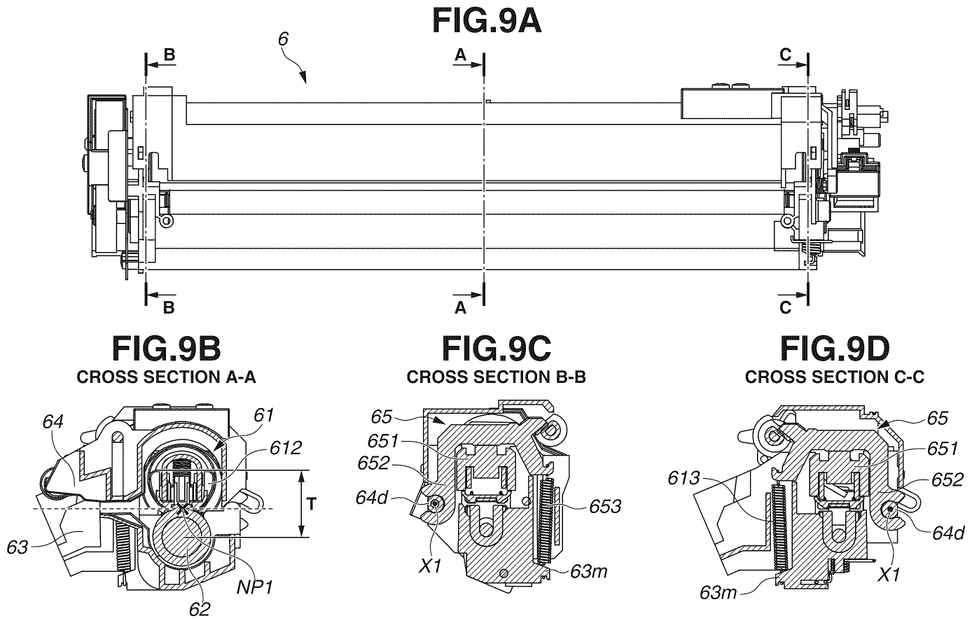

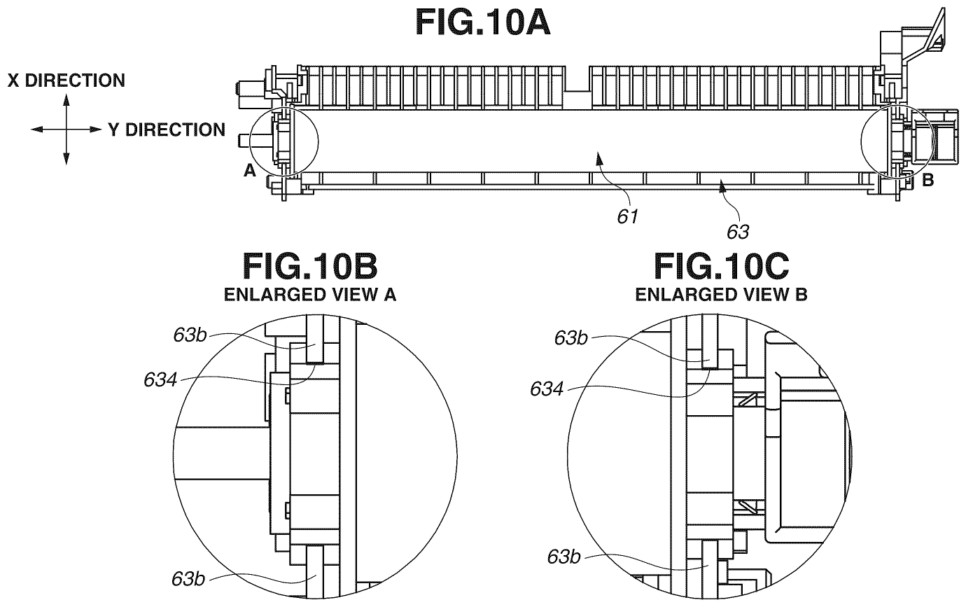

As illustrated in FIGS. 9A to 9D and FIGS. 10A to 10C, the fixing device 6 includes pressure mechanisms 65 that apply pressure to form the fixing nip NP1 between the heating unit 61 and the pressure roller 62. The pressure mechanisms 65 are located one at each end in the Y direction of the lower frame 63. Since the structures of the pressure mechanisms 65 on one side and the other side in the Y direction are substantially the same, the following description mainly focuses on one side in the Y direction.

Each pressure mechanism 65 includes a transmission member (transmission member 651) that supports the heating unit 61 at the corresponding end in the Y direction and transmits pressure to the stay 613, which is supported by the pairs of rails 63b so as to be movable in the Z direction. The pressure mechanism 65 further includes a pressure arm 652 for applying pressure to the transmission member 651 mounted on the lower frame 63 to form the fixing nip NP1. In addition, the pressure mechanism 65 includes a pressure spring 653 stretched between the lower frame 63 and the pressure arm 652. The pressure spring 653 generates pressure and presses the pressure arm 652 against the transmission member 651. The lower frame 63 includes pressure arm support portions 64d that rotatably support the pressure arm 652 about a rotation center axis X1. The pressure arm support portions 64d are each a substantially cylindrical projection. Each pressure spring 653 is a tension coil spring that biases the pressure arm 652 toward the pressure roller 62. The lower frame 63 includes spring hook portions 63m on each of which one end of the corresponding pressure spring 653 is hooked. For example, portions of the lower frame 63, which is made of resin, at each of which the corresponding pressure arm support portion 64d is provided may be made of metal. Alternatively, only portions of the pressure arm support portions 64d that contact the pressure arm 652 may be provided with metal members. Alternatively, portions of the lower frame 63, which is made of resin, at each of which the corresponding spring hook portion 63m is provided may be made of metal.

At least a part of the rotation center axis X1 about which the respective pressure arms 652 rotate is located, when viewed in the Y direction, on an upstream side of the fixing nip NP1 in the recording material conveyance direction and within a range T in the Z direction (a direction orthogonal to the longitudinal direction of the belt 614 and the recording material conveyance direction) illustrated in FIG. 9B. Here, the range T in the Z direction illustrated in FIG. 9B extends between a rotation center of the pressure roller 62 in the Z direction and an end of the holder 612 on the pressure arm side (the end of the holder 612 farthest from the rotation center of the pressure roller 62 in the Z direction). There is a distance in the Z direction between a portion where the respective pressure arms 652 press the transmission member 651 and the rotation center axis X1, so that each pressure arm 652 is bent into an L shape. The upstream side in the recording material conveyance direction is the photoconductor drum 11 side of the fixing nip NP1 in the X direction.

### [Pressure Release Mechanism]

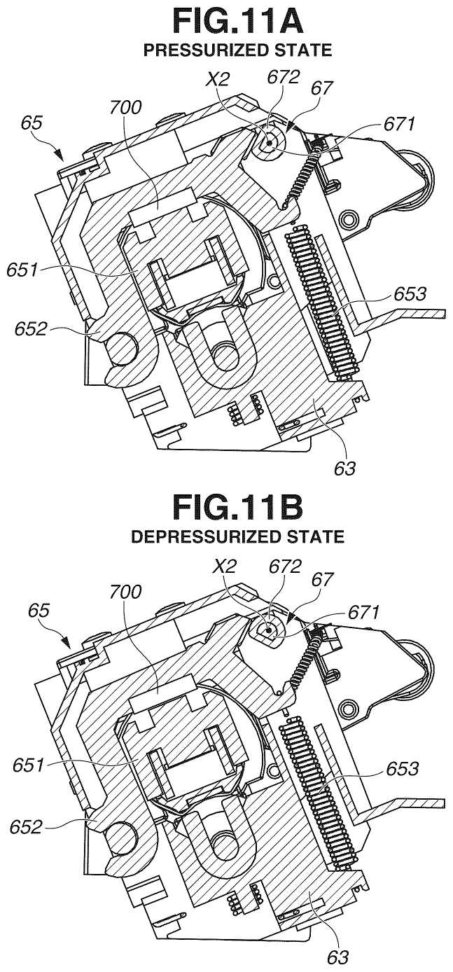

As illustrated in FIGS. 11A and 11B, the fixing device 6 further includes pressure release mechanisms 67 for releasing nip pressure applied to the fixing nip NP1 between the heating unit 61 and the pressure roller 62 as illustrated in FIG. 9B. The pressure release mechanisms 67 include a camshaft 671 and cams 672. The lower frame 63 supports the pressure springs 653 and rotatably supports the pressure arms 652 and the cams 672. Each cam 672 is located at the corresponding end of the lower frame 63 in the Y direction. Since the structures of the pressure release mechanism 67 on one side and the other side in the Y direction are substantially the same, the following description mainly focuses on the structure on one side in the Y direction.

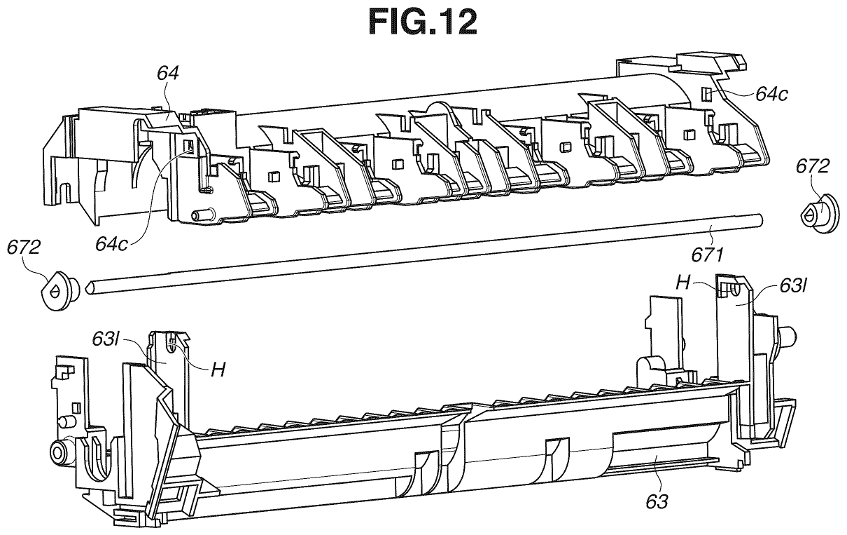

As illustrated in FIG. 12, the camshaft 671 extends in the Y direction and is made of, for example, metal. Each cam 672 is fixed to the corresponding end of the camshaft 671 in the Y direction. In other words, the cams 672 are mounted on the camshaft 671. The cams 672 rotate as the camshaft 671 rotates. The lower frame 63 includes shaft support portions 63l that rotatably support the camshaft 671. As illustrated in FIG. 12, the shaft support portions 63l are each disposed at the corresponding end of one end and the other end of the lower frame 63 in the Y direction. The shaft support portions 63l each have a hole H that rotatably supports the camshaft 671.

As illustrated in FIG. 12, the upper frame 64 has grooves 64C that rotatably support the camshaft 671. Each groove 64C is disposed at the corresponding end of one end and the other end of the upper frame 64 in the Y direction. The camshaft 671 is held between the upper frame 64 and the lower frame 63. As illustrated in FIGS. 11A and 11B, the camshaft 671 is rotatably supported about an axis X2. The cams 672 can each press the pressure arm 652 against the biasing force of the pressure spring 653. Specifically, each cam 672 is rotatable between a first position illustrated in FIG. 11A and a second position illustrated in FIG. 11B. In the present embodiment, a wear-preventing member (protective member) 700 is provided between the pressure arm 652 and the transmission member 651 as illustrated in FIGS. 11A and 11B.

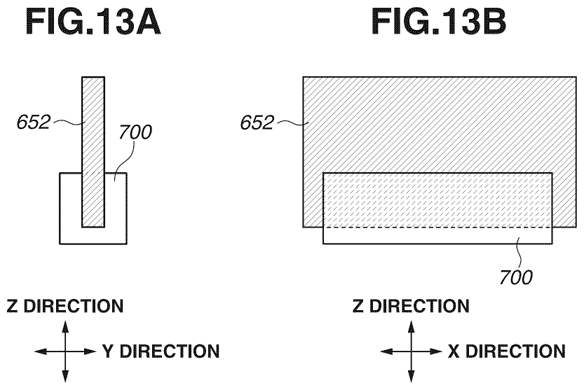

As illustrated in FIGS. 13A and 13B, the wear-preventing member 700 is a U-shaped member made of resin and is attached to a lower surface of the pressure arm 652, which is made of a metal sheet, so as to sandwich the pressure arm 652 in the Y direction in a U-shaped manner. In the present disclosure, the lower frame 63 is made of resin, and both the pressure arm support portions 64d, which rotatably support the pressure arm 652 about the rotation center axis X1, and the spring hook portions 63m are also made of resin, all of which are disposed on the lower frame 63. A large force is applied to the pressure arm support portions 64d and the spring hook portions 63m as a reaction force resulting from the pressure arm 652 being pressed. Thus, in view of deformation of the pressure arm support portions 64d and its surrounding portions, the pressure arm support portions 64d can be each disposed at a position close to the corresponding bearing 62c that supports the shaft 62a of the pressure roller 62.

The reason for this arrangement is that the shaft 62a of the pressure roller 62 is made of metal and can serve as a structural member. In a case where each pressure arm support portion 64d is disposed near the corresponding bearing 62c, the pressure arm 652 inevitably takes on an L-shape.

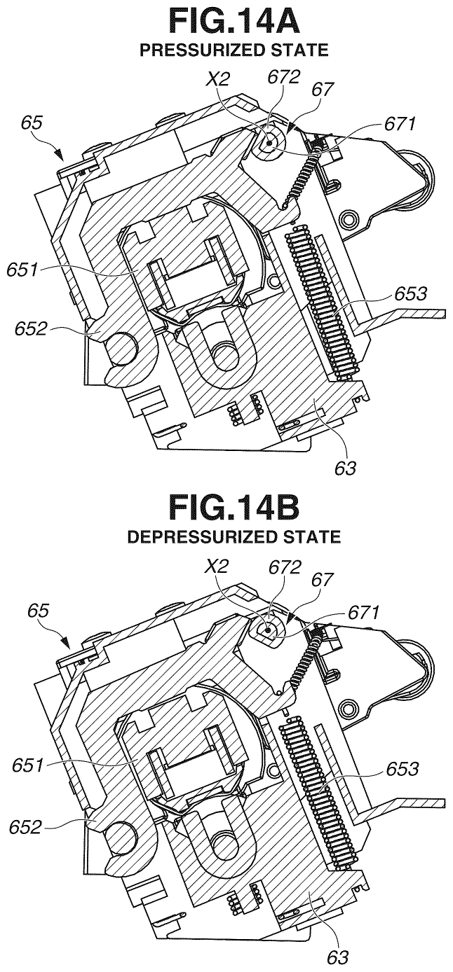

FIGS. 14A and 14B illustrate a configuration of Comparative Example 1. In Comparative Example 1, no member is provided between the pressure arm 652 and the transmission member 651 as illustrated in FIGS. 14A and 14B.

### [Effect of Present Embodiment]

In the present embodiment, since the pressure arm support portions 64d and the spring hook portion 63m, on each of which one end of the corresponding pressure spring 653 is hooked, are made of resin, the rigidities of these components are low as compared with a case where they are made of a high-rigidity material(s), such as metal. The pressure roller 62 is configured to be driven to rotate by a driving force transmitted from a drive source of the image forming apparatus 1, but the fixing device 6 experiences a certain amount of vibration due to runout of the pressure roller 62 or runout of a gear (not illustrated) that transmits the rotational drive.

The absence of the wear-preventing member 700 causes the transmission member 651, which is made of resin, and the pressure arm 652, which is made of metal, to rub against each other due to vibration, resulting in wear primarily on a portion of the transmission member 651 that contacts the pressure arm 652. If the transmission member 651 becomes worn, particles resulting from wear may enter between the shaft 62a and the bearing 62c of the pressure roller 62, leading to wear of the bearing 62c. Furthermore, if the transmission member 651 is significantly worn, the pressing force may decrease.

In the present embodiment, the wear-preventing member 700 is disposed at a portion of the pressure arm 652 that contacts the transmission member 651. Thus, even if vibration of the fixing device 6 as described above occurs, direct rubbing between the transmission member 651 and the pressure arm 652, which is made of metal, is prevented, thus reducing wear of the transmission member 651 as compared with Comparative Example 1.

### Second Embodiment

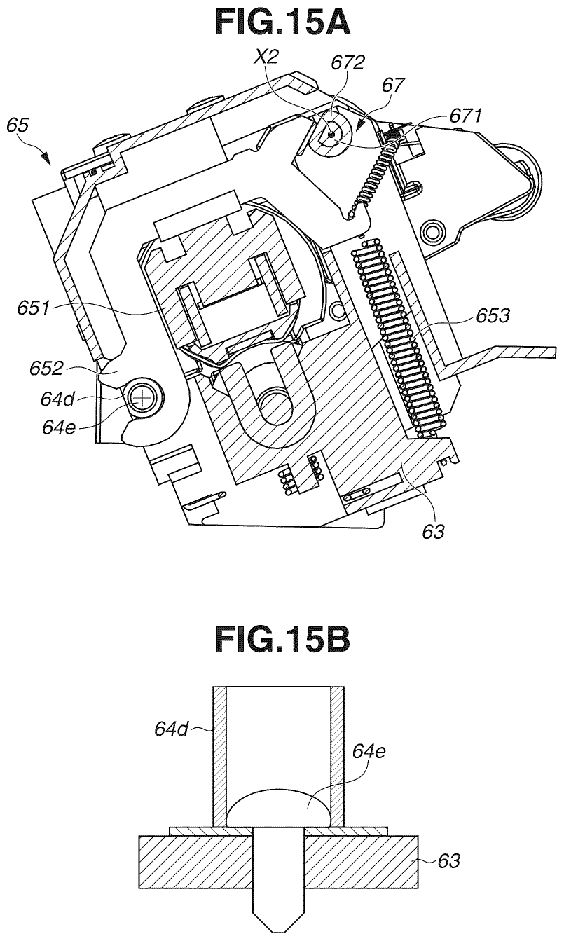

In a second embodiment, the same configurations and controls as those in the first embodiment are denoted by the same reference numerals and descriptions thereof are omitted. In the first embodiment, the pressure arm support portions 64d are made of resin, but in the second embodiment, the pressure arm support portions 64d are made of metal separate from the lower frame 63, as illustrated in FIGS. 15A and 15B. The pressure arm support portions 64d can be attached to the lower frame 63 with screws 64e. Since the pressure arm support portions 64d are made of metal, each pressure arm support portion 64d has high rigidity as compared with the first embodiment. However, since the lower frame 63 is made of resin, an issue similar to the issue targeted to be solved in the first embodiment may arise even though the pressure arm support portions 64d are made of metal. Thus, in the present embodiment as well, the wear-preventing member 700 is disposed as in the first embodiment, thus reducing wear of the transmission member 651.

### Third Embodiment

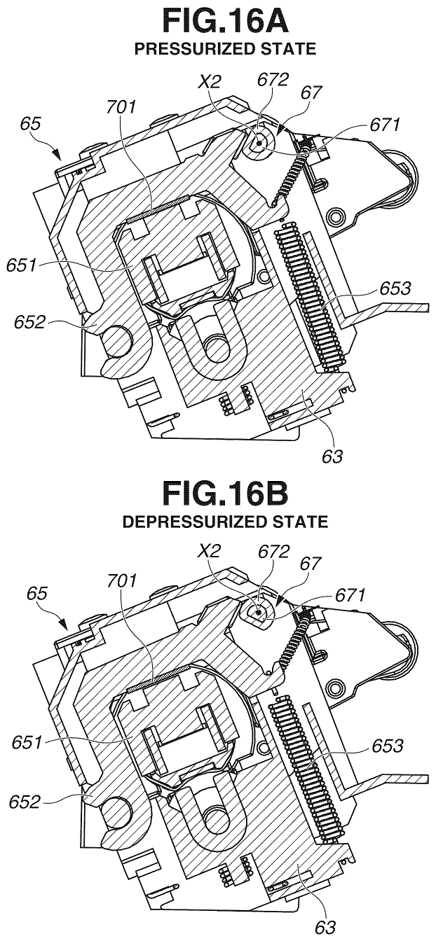

In a third embodiment, the same configurations and controls as those in the first and second embodiments are denoted by the same reference numerals and descriptions thereof are omitted. As illustrated in FIGS. 16A and 16B, the present embodiment is characterized in that, instead of the wear-preventing member 700 described in the first embodiment, a lubricant 701 is applied so as to cover a portion of the respective pressure arms 652 that contact the corresponding transmission members 651.

Application of the lubricant 701 leads to reduction in sliding resistance even in a case where the respective pressure arms 652 and the corresponding transmission members 651 rub against each other, thus reducing the amount of wear. Since the wear-preventing member 700 is not used, the number of components can be reduced as compared with the first embodiment. A lubricant having heat resistance suitable for the usage environment and relatively high viscosity can be used, with the high viscosity allowing the lubricant to remain between the respective pressure arms 652 and the corresponding transmission members 651.

### [Additional Notes]

The disclosure of the embodiments also includes the following configuration examples and method examples.

### (Item 1)

A fixing device configured to fix a toner image formed on a recording material onto the recording material while nipping the recording material at a fixing nip and conveying the recording material through the fixing nip, the fixing device comprising:
a belt unit including a belt which is cylindrical, a heater disposed in an internal space of the belt, a holder that holds the heater, and a regulating member disposed at a position facing an end portion of the belt in a longitudinal direction of the belt and configured to regulate movement of the belt in the longitudinal direction of the belt;
a pressure roller configured to contact an outer circumferential surface of the belt and to form the fixing nip between the pressure roller and the belt while sandwiching the belt together with the heater;
a frame that rotatably supports the pressure roller and supports the regulating member to support the belt unit; and
a pressure arm rotatably disposed on the frame and configured to apply pressure to the regulating member to form the fixing nip, the pressure arm being made of metal,
wherein the frame is made of resin,
wherein, when viewed in the longitudinal direction of the belt, a rotation center axis of the pressure arm is located on an upstream side of the fixing nip in a recording material conveyance direction and between a rotation center of the pressure roller and an end portion of the holder on a side where the pressure arm is disposed in a direction orthogonal to the longitudinal direction of the belt and the recording material conveyance direction, and
wherein a protective member made of resin is disposed between the pressure arm and a portion of the regulating member that is pressed by the pressure arm, and the pressure arm presses the regulating member via the protective member.

### (Item 2)

The fixing device according to item 1, wherein the pressure arm is bent into an L shape when viewed in the longitudinal direction of the belt.

### (Item 3)

The fixing device according to item 1 or item 2, wherein a rotation shaft of the pressure arm is made of metal and attached to the frame.

### (Item 4)

A fixing device configured to fix a toner image formed on a recording material onto the recording material while nipping the recording material at a fixing nip and conveying the recording material through the fixing nip, the fixing device comprising:
a belt unit including a belt which is cylindrical, a heater disposed in an internal space of the belt, a holder that holds the heater, and a regulating member disposed at a position facing an end portion of the belt in a longitudinal direction of the belt and configured to regulate movement of the belt in the longitudinal direction of the belt;
a pressure roller configured to contact an outer circumferential surface of the belt and to form the fixing nip between the pressure roller and the belt while sandwiching the belt together with the heater;
a frame that rotatably supports the pressure roller and supports the regulating member to support the belt unit; and
a pressure arm rotatably disposed on the frame and configured to apply pressure to the regulating member to form the fixing nip, the pressure arm being made of metal,
wherein the frame is made of resin,
wherein, when viewed in the longitudinal direction of the belt, a rotation center axis of the pressure arm is located on an upstream side of the fixing nip in a recording material conveyance direction and between a rotation center of the pressure roller and an end portion of the holder on a side where the pressure arm is disposed in a direction orthogonal to the longitudinal direction of the belt and the recording material conveyance direction, and
wherein a lubricant is applied between the pressure arm and a portion of the regulating member to be pressed by the pressure arm, and the pressure arm presses the regulating member via the lubricant.

### (Item 5)

The fixing device according to item 4, wherein the pressure arm is bent into an L shape when viewed in the longitudinal direction of the belt.

### (Item 6)

The fixing device according to item 4 or item 5, wherein a rotation shaft of the pressure arm is made of metal and attached to the frame.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-219606, filed Dec. 16, 2024, which is hereby incorporated by reference herein in its entirety.

What is claimed is:

1. A fixing device configured to fix a toner image formed on a recording material onto the recording material while nipping the recording material at a fixing nip and conveying the recording material through the fixing nip, the fixing device comprising:
a belt unit including a belt which is cylindrical, a heater disposed in an internal space of the belt, a holder that holds the heater, and a regulating member disposed at a position facing an end portion of the belt in a longitudinal direction of the belt and configured to regulate movement of the belt in the longitudinal direction of the belt;
a pressure roller configured to contact an outer circumferential surface of the belt and to form the fixing nip between the pressure roller and the belt while sandwiching the belt together with the heater;
a frame that rotatably supports the pressure roller and supports the regulating member to support the belt unit; and
a pressure arm rotatably disposed on the frame and configured to apply pressure to the regulating member to form the fixing nip, the pressure arm being made of metal,
wherein the frame is made of resin,
wherein, when viewed in the longitudinal direction of the belt, a rotation center axis of the pressure arm is located on an upstream side of the fixing nip in a recording material conveyance direction and between a rotation center of the pressure roller and an end portion of the holder on a side where the pressure arm is disposed in a direction orthogonal to the longitudinal direction of the belt and the recording material conveyance direction, and
wherein a protective member made of resin is disposed between the pressure arm and a portion of the regulating member that is pressed by the pressure arm, and the pressure arm presses the regulating member via the protective member.

2. The fixing device according to claim 1, wherein the pressure arm is bent into an L shape when viewed in the longitudinal direction of the belt.

3. The fixing device according to claim 1, wherein a rotation shaft of the pressure arm is made of metal and attached to the frame.

4. A fixing device configured to fix a toner image formed on a recording material onto the recording material while nipping the recording material at a fixing nip and conveying the recording material through the fixing nip, the fixing device comprising:
a belt unit including a belt which is cylindrical, a heater disposed in an internal space of the belt, a holder that holds the heater, and a regulating member disposed at a position facing an end portion of the belt in a longitudinal direction of the belt and configured to regulate movement of the belt in the longitudinal direction of the belt;
a pressure roller configured to contact an outer circumferential surface of the belt and to form the fixing nip between the pressure roller and the belt while sandwiching the belt together with the heater;
a frame that rotatably supports the pressure roller and supports the regulating member to support the belt unit; and
a pressure arm rotatably disposed on the frame and configured to apply pressure to the regulating member to form the fixing nip, the pressure arm being made of metal,
wherein the frame is made of resin,
wherein, when viewed in the longitudinal direction of the belt, a rotation center axis of the pressure arm is located on an upstream side of the fixing nip in a recording material conveyance direction and between a rotation center of the pressure roller and an end portion of the holder on a side where the pressure arm is disposed in a direction orthogonal to the longitudinal direction of the belt and the recording material conveyance direction, and
wherein a lubricant is applied between the pressure arm and a portion of the regulating member to be pressed by the pressure arm, and the pressure arm presses the regulating member via the lubricant.

5. The fixing device according to claim 4, wherein the pressure arm is bent into an L shape when viewed in the longitudinal direction of the belt.

6. The fixing device according to claim 4, wherein a rotation shaft of the pressure arm is made of metal and attached to the frame.
